(19) United States
(12) Patent Application Publication
(10) Pub. No.: US 2003/0229527 A1
(43) Pub. Date: Dec. 11, 2003

(54) Decision aiding tool

(76) Inventors: Stephen Michael Fletcher, Farnborough (GB); Elizabeth Jane Humphreys, Farnborough (GB); Averil Myvanwy Horton, Twickenham (GB)

Correspondence Address: A. Blair Hughes, McDonnell Boehnen Hulbert & Berghoff, 32nd Floor, 300 S. Wacker Drive, Chicago, IL, 60606, US

(21) Appl. No.: 10/411,449

(22) Filed: Apr. 10, 2003

(30) Foreign Application Priority Data
Apr. 18, 2002 (GB) 0208894.6

(51) Int. Cl. G06F 17/60

(52) U.S. Cl. 705/7

(57) ABSTRACT

A decision aiding tool uses quantifiable and knowable information as a proxy for generally unknowable information in order to provide basis for assessment of potential for achieving a goal. The knowable (non-specialist) information is linked to the goal to be assessed and to the unknowable (specialist) information via a decision tree. This is incorporated in a software toolkit for conversion of non-specialist information, elicited from a user, into specialist information. The toolkit presents to the user a series of Proxy Questions, each relating to aspects of the knowable information, and a number of possible Statements which may be selected in response. Each selected Statement is then quantified to provide a score and, with appropriate weighting, the scores are aggregated in accordance with the structure of the decision tree. This provides quantitative indicators of the unknowable information and of the potential for achieving the goal.

This invention relates to tools, systems and methods for information analysis and to applications thereof for use as an aid to making decisions. It is particularly concerned with automated assessment of a number of potential options as an aid to making decisions, such as, for example, those concerning investment. In particular, it relates to a method and system for providing an assessment of the commercial potential of a new technology.

In many management situations it becomes essential to make a rapid assessment of competing demands for scarce resources. Whether these resources are time, money or people, the situations in which the need for an allocation decision will arise occur often. One particular example however is found in the field of exploitation of new technology.

It is well known that scientific research and development is costly and is generally undertaken with no guarantee of any return for the investment made. Moreover in order to protect that investment, patent applications must be made at a very early stage in the development process, before any significant efforts are made at commercialisation and certainly well in advance of any indication of the commercial success or otherwise of a new product. Corporate research and development strategists, as well as potential technology investors, have to sift through a wealth of new ideas and select those worthy of funding, and the extent to which they will be funded, for further development, patent protection and detailed marketing analysis and activities.

Of course many companies do attempt to make some formalised assessment of the commercial potential of any new technology, and to focus financial investment and future technological research accordingly. However, this is an inexact science, and it often takes many years experience in the commercial field to be able to make a reasonable judgment. It is well known that technical merit does not equate to commercial success, which is subject to the vagaries of numerous factors. These factors can act and interact in highly complex ways, and an early investment in expert market analysis is frequently wasted. Moreover, obtaining the information on which to base an expert decision frequently incurs further expense and it is often late in the cycle that a project is finally abandoned. This leads to wasted resources, which an earlier risk analysis assessment could have avoided.

The need for patent protection presents a further drain on resources. The general absence of early indicators of commercial success means that much investment is made in securing unnecessary patent protection for certain inventions, whilst other commercially successful products are later found to be insufficiently protected. Universities too have to contend with the competing demands of an academic's desire to publish quickly and the need for secrecy until the case for a patent application can be assessed.

There is therefore a perceived need in many fields to provide a system with which a quick and easy assessment of competing demands can be made. In particular in the field of exploitation of new technology, there is a perceived need for a tool with which an assessment of the technology in terms of its commercial exploitation potential can be made. It is an object of the present invention to provide a methodology which can be followed by an expert in the relevant specialism in order to develop such a system. It is accordingly a further object of the present invention to provide a system with which a quick and easy assessment of competing demands can be made.

In a first aspect, the present invention provides a method of decision tree analysis by which a goal to be assessed in terms of a comparison between a number of different scenarios is linked with quantifiable parameters, thereby enabling a quantitative value to be obtained as a measure of the goal, the method comprising the steps of:

a) At a first level of the decision tree, associating the goal with Required Information which, if all aspects of the Required Information were known, would enable a straightforward assessment of the goal to be made for each of the different scenarios;

b) At a second level of the decision tree, linking proxy information to the Required Information wherein the proxy information comprises a number of aspects, each of which is a generally estimable parameter, and each aspect of the proxy information is assumed to make a contribution to each aspect of the Required Information; and

c) At a third and, possibly, subsequent level of the decision tree, extracting Proxy Factors, the Proxy Factors being not insignificant components of each aspect of the proxy information linked to one of the aspects of the Required Information through the decision tree structure and wherein the Proxy Factors are quantifiable parameters.

This method can be used to establish a link between information on which a decision can be based and knowable and quantifiable information. Generation of a quantitative value representative of the potential of each scenario to achieve the goal then becomes a possibility. If the link is derived by an expert in the relevant field, it will in this way incorporate his expertise in the decision tree. The Proxy Factors should be selected as quantities of which an intended non-expert user will have knowledge, and can be tailored to take advantage of any expertise the user may have in another field. The method of this invention is accordingly referred to as a proxy methodology; that is, knowable information is developed as a proxy for required information.

The method preferably comprises the further steps of:

a) Obtaining quantities representative of the Proxy Factors, and

b) For at least one of:

each aspect of Required Information,

each aspect of proxy information, and

the overall goal,

generating a Result for comparison between the different scenarios wherein each respective Result is generated by aggregating and normalising the representative quantities in accordance with links established by the decision tree structure.

This embodiment of the invention provides a way in which, once the expertise is incorporated in the decision tree, the non-expert user has only to supply estimates for the tailored Proxy Factors to enable the link to be followed in reverse and so convert the user's non-specialist input (or knowable information) to specialist output.

The representative quantities of step (a) above may be obtained by the further steps of:

a) Presenting to a user a series of predetermined Proxy Questions (PQₙ), wherein each Proxy Question relates to a Proxy Factor,

b) Prompting the user to select, for each Proxy Question (PQₙ), one of a number of predetermined Proxy Statements (PS_{n,m(n)}), each Proxy Statement being a relevant answer to its respective Proxy Question (PQₙ), and,

c) On selection by the user of one Proxy Statement (PS(nm)) for each Proxy Question (PQₙ), multiplying a predetermined Assigned Value (AV(nm)) for the Proxy Statement (PS(nm)), the Assigned Value being a numerical representation of the benefit of the selected Proxy Statement (PS(nm)) to the goal relative to the benefit of all the unselected Statements corresponding to the same Proxy Question (PQₙ), by a predetermined weighting (wₙ) for the Proxy Question (PQₙ), the weighting being a numerical representation of the magnitude of the effect on the goal of the Proxy Factor corresponding to the Question (PQₙ), and to generate the Result.

If the Proxy Questions (PQₙ) are so-phrased as to elicit from a non-expert user responses (in the form of Proxy Statements (PS(nm)) which are meaningful representations of the Proxy Factors, then this method provides a means by which information concerning the Proxy Factors is gathered and converted to useable (specialist) information. Both the weighting scheme and Assigned Values should be predetermined by an expert, in order to provide sensible conversion with further incorporation of specialist knowledge.

The goal to be assessed may be the commercial potential of new technology, the Required Information may comprise three aspects relating to Income, Costs and Risks, the proxy information may comprise three aspects relating to Product, Market and Barriers, and the Proxy Factors may be Proxy Exploitation Factors. The Proxy Exploitation Factors preferably relate to at least three of: Product or Process Benefits, Sector Attractiveness, Competition and Gross Market Size. They may additionally relate to at least one of: External Barriers, Exploitation Timescale, Technology Content and Technology Status. They may also additionally relate to: Internal Barriers, Technology Level, Third Parties and Intellectual Property.

These embodiments of the invention can be used advantageously in a technical research environment. Typically, a research and development organisation will employ many scientists, but relatively fewer commercial experts. By using the proxy methodology of this invention, a system can be established by which technical information, which is more readily available to a scientist, is converted into commercial information.

This method enables meaningful assessment to be made of the commercial potential of a new technology by a scientist, without the need for detailed liaison with a commercial expert. The range of Proxy Exploitation Factors listed above are believed to provide increasing refinement to any estimation of overall commercial exploitability of a new technology. This presentation of Proxy Questions (PQₙ), relating to these Factors, with selectable Proxy Statements (PS_{n,m}), requires very little commercial knowledge on the part of the scientist and, by following this method, the relative merits of pursuing commercialisation of available technologies may be rapidly assessed. This is clearly advantageous to anyone having to make a decision as to which project or projects to allocate scarce resources.

In a second aspect the present invention provides a method of generating a quantitative value representative of potential for achieving a goal, the method comprising the steps of:

a) presenting to a user a series of predetermined Proxy Questions (PQₙ) and, for each Proxy Question (PQₙ), a set of Proxy Statements (PS_{n,m(n)}); wherein each Proxy Question (PQₙ) has a predetermined associated normalised Weighting value (wₙ) and each Proxy Statement (PS_{n,m(n)}) has a pre-determined associated Assigned Value (AV_{n,m(n)});

b) accepting a Response comprising a selected set of Proxy Statements (PS(nm)) from the user;

c) replacing each Proxy Statement (PS(nm)) within the Response with its associated Assigned Value (AV(nm));

d) multiplying each Assigned Value (AV(nm)) by the Weighting value (wₙ) associated with the Proxy Question (PQₙ) which prompted for its associated Proxy Statement (PS(nm)) to obtain a set of score indicators (scoreₙ);

e) aggregating predetermined combinations of score indicators (scoreₙ) together to obtain a selection of result indicators; and

f) displaying the result indicators to the user.

This aspect of the invention provides a readily-automated methodology by which non-specialist and quantifiable information can be elicited by the use of Proxy Questions (PQₙ) and used as a proxy for specialist information, enabling assessment of the specialist information to be made.

In a third aspect, the present invention provides a computer-readable medium embodying instructions for execution by a processor, the computer-readable medium comprising program code for carrying out the above steps.

In a fourth aspect, the present invention provides a computer system configured to provide scores for the purpose of assessing competing demands on resources, the system comprising:

memory means for storing data comprising Proxy Questions (PQₙ), weightings (wₙ) for each Proxy Question (PQₙ), Proxy Statements (PS_{n,m(n)}) and Assigned Values (AV_{n,m(n)}) associated with the Proxy Statements (PS_{n,m(n)}),

a display means arranged to display the Proxy Questions (PQₙ) and, for each Proxy Question (PQₙ), a set of Proxy Statements (PS_{n,m(n)}) in a format to prompt the user to select one Proxy Statement (PS(nm)) from the set,

input means arranged to accept inputs from the user, the inputs being characteristic of the Proxy Statements (PS(nm)),

interface means arranged to provide communication between the display means, input means and the rest of the computer,

a processor, the processor being responsive to the inputs characteristic of the Proxy Statements (PS(nm)) selected to determine a series of scores relating to this combination of Proxy Statements (PS(nm)) and to output the series of scores or a subset thereof via the interface for display by the display means, wherein

the Proxy Questions (PQₙ) are associated with respective Proxy Factors in such a way that an answer (PS_{n,m(n)}) to the Question (PQₙ) is informative as to an impact of the associated Proxy Factor on the score or scores to be provided,

the Proxy Factors are derived from a decision tree structure, in which linkages are provided between the Proxy Factors and aspects of proxy information and between the aspects of proxy information and aspects of Required Information, the Required Information being that which, if known, would permit a straightforward assessment of the competing demands to be made, and

the proxy information comprises parameters which are more readily estimable than the aspects of the Required Information.

The processor preferably further includes:

scoring means for calculating a series of score indicators, one for each user-selected Proxy Statement (PS(nm)), wherein each score indicator is calculated by multiplying the Assigned Value (AV(nm)) associated with that user-selected Proxy Statement (PS(nm)) by the weighting (wₙ) for the Proxy Question (PQₙ) which elicited input of that user-selected Proxy Statement (PS(nm)), whereby each score indictor can be considered a measure of the contribution of the associated Proxy Factor to the overall assessment being made, and

a decision tree module arranged to aggregate combinations of score indicators, each such combination corresponding to linkages in the decision tree structure between one aspect of Required Information, one aspect of proxy information or the whole tree and the Proxy Factor(s), thereby providing quantitative values which can be used to assess the competing demands of different scenarios with different sets of user-selected Proxy Statements (PS(nm)).

Embodiments of the invention will now be described by way of example only and with reference to the accompanying drawings.

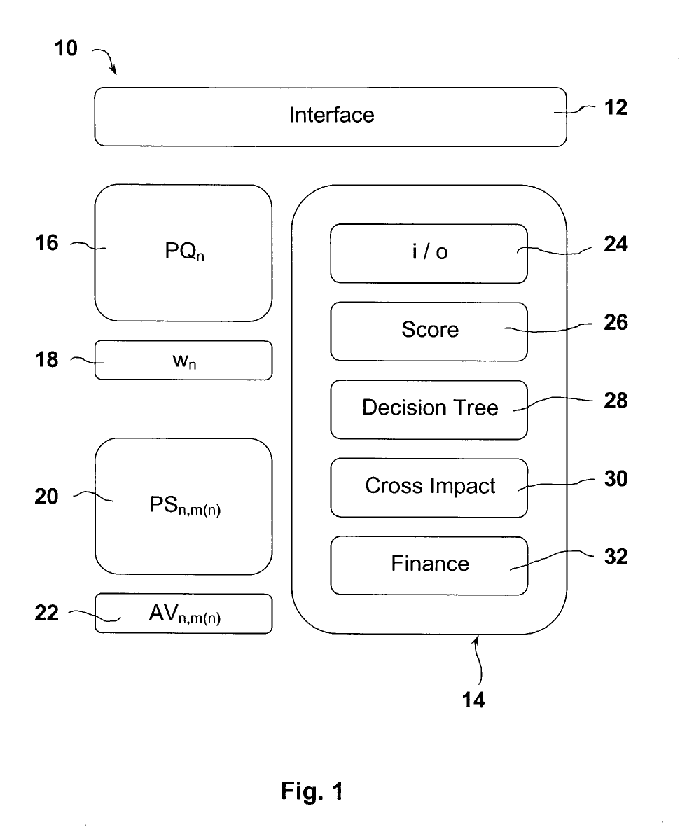

FIG. 1 is a representative illustration of a computer system configured in accordance with an aspect of this invention.

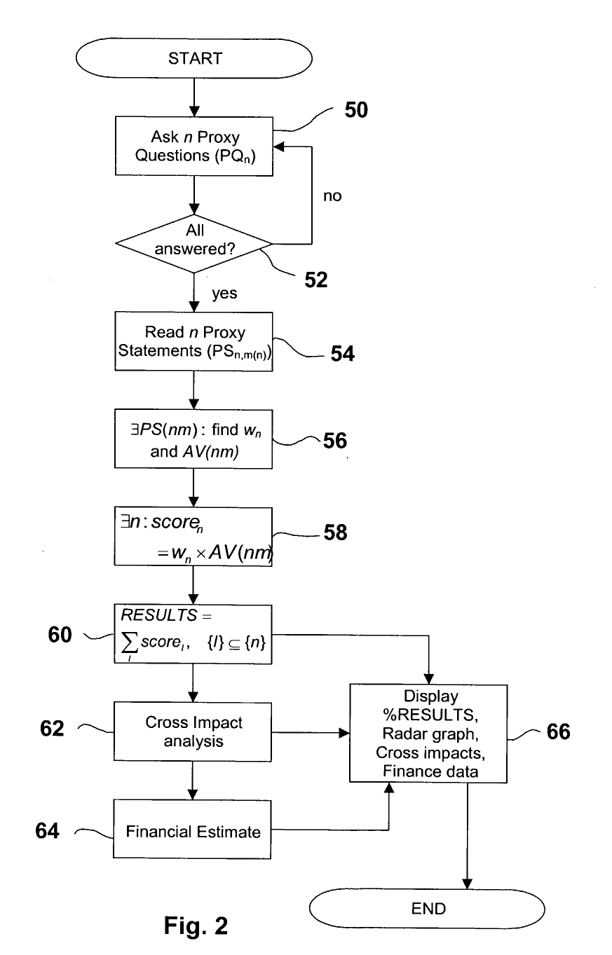

FIG. 2 is a functional diagram indicating the process steps carried out in accordance with another aspect of this invention.

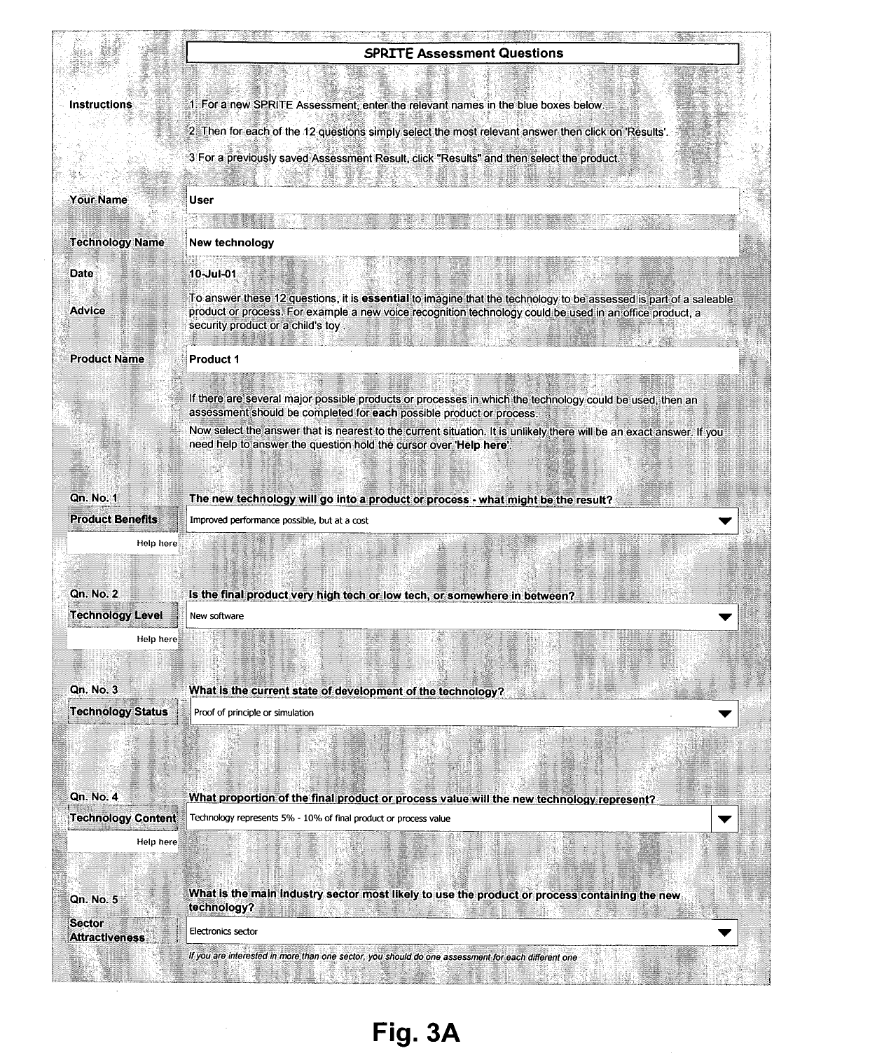

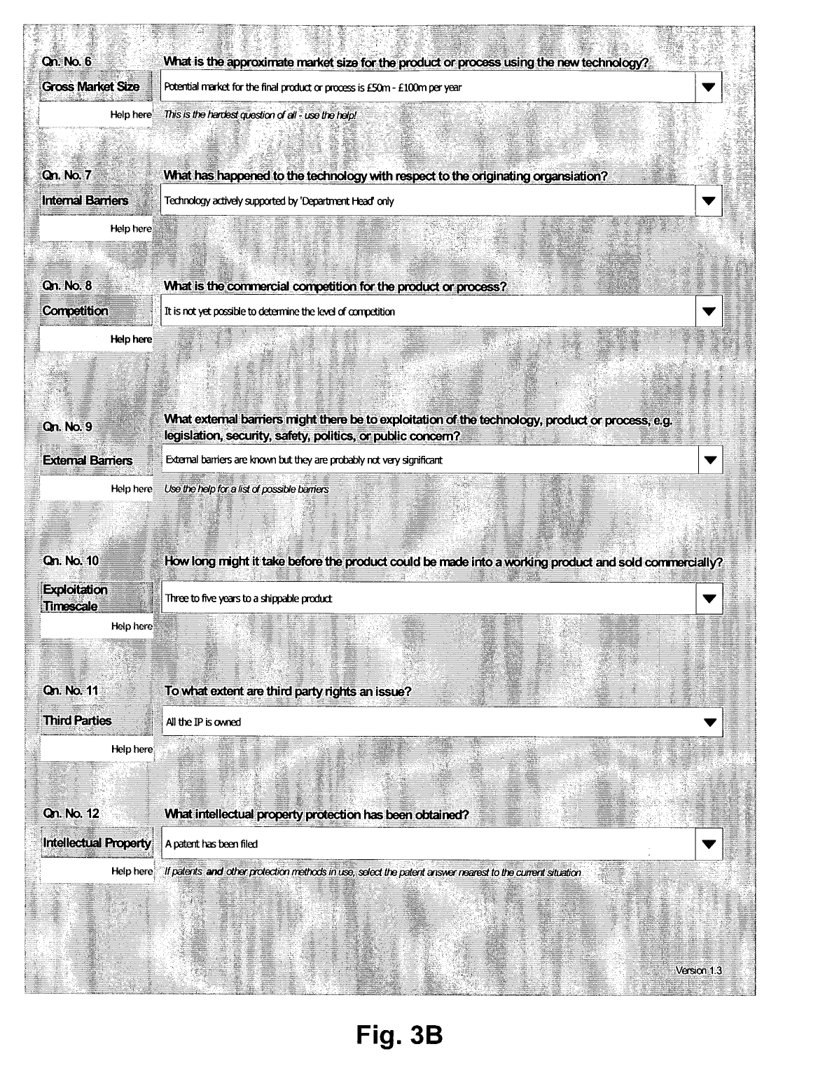

FIGS. 3A and 3B comprise an exemplary input screen to prompt for inputs to be analysed in accordance with one embodiment of this invention.

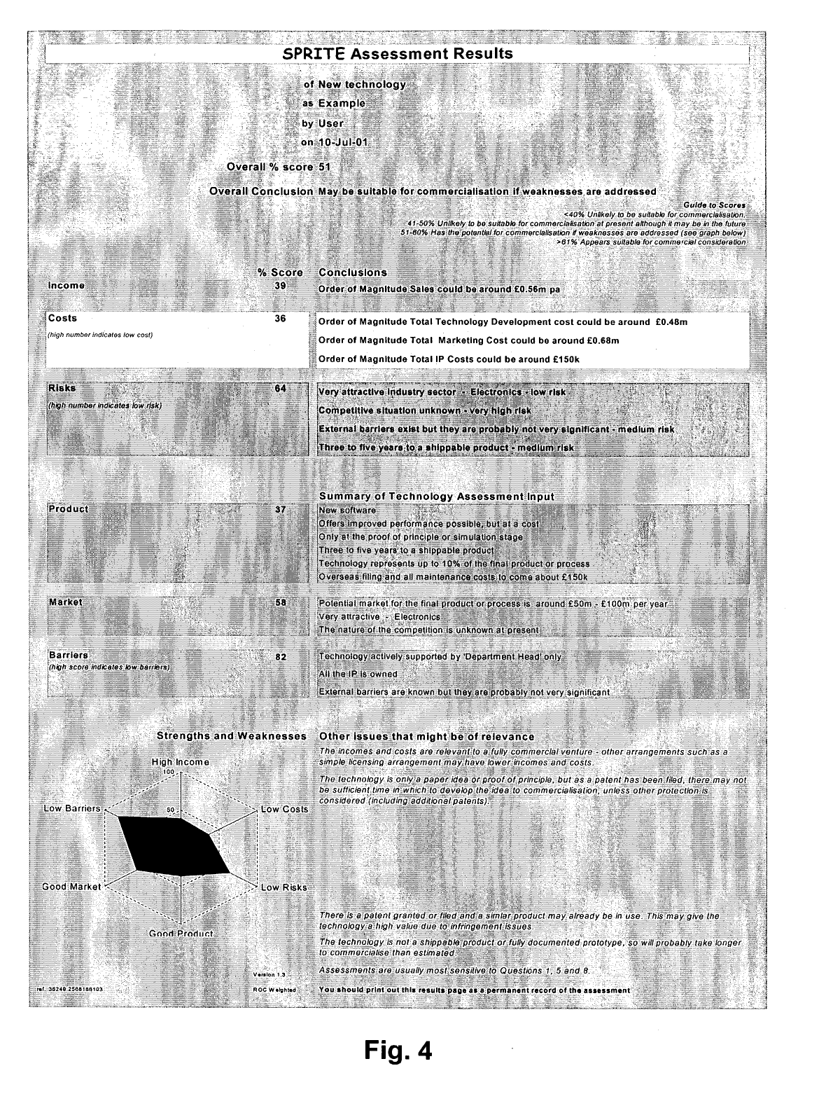

FIG. 4 is an exemplary output screen generated by the same embodiment of this invention as used to provide the input screen illustrated in FIG. 3.

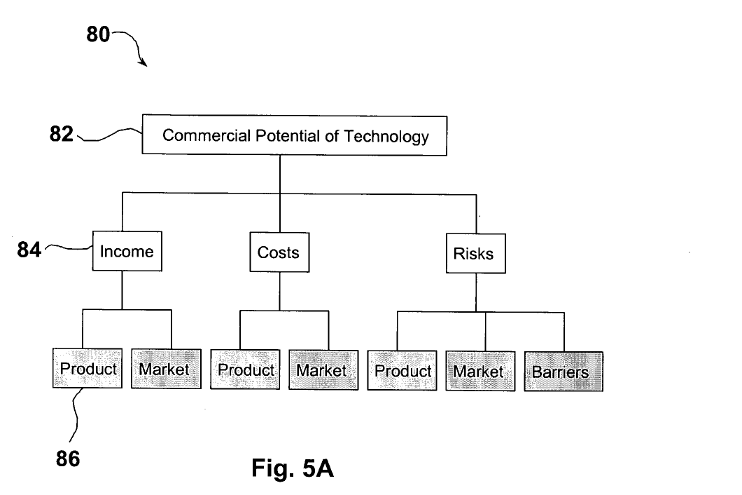

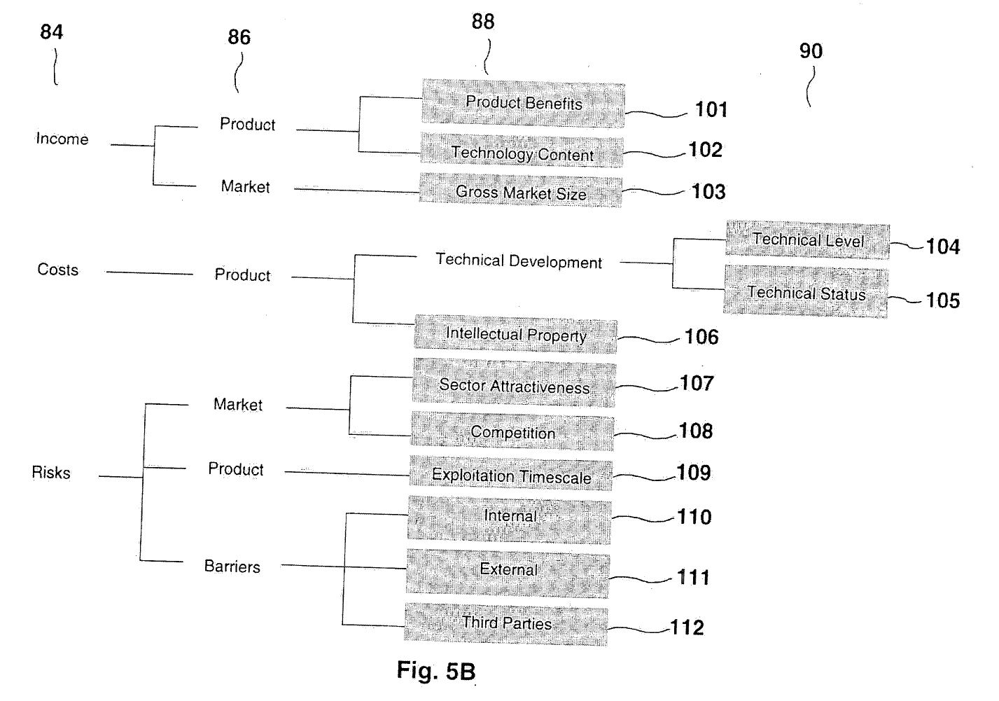

FIGS. 5A and 5B are schematic representations of a decision tree used in developing the embodiment illustrated in FIGS. 3 and 4 which links obtainable information to the Required Information in accordance with the proxy methodology basis of this invention.

FIG. 1 illustrates a representative computer system configured in accordance with an embodiment of the invention. The computer system 10 comprises an interface 12 between a user and the computer 10, a processor 14 and four database structures 16-22. The processor 14 itself contains five program modules: an input-output (i/o) module for reading and writing data from and to the databases 16-22 and from and to the interface 12, a scoring module 26, a decision tree module 28, a cross impact module 30 and a finance module 32. The database structures comprise a Proxy Questions (PQₙ) database 16, a Weights (wₙ) database 18, a Proxy Statements (PS_{n,m(n)}) database 20 and an Assigned Values (AV_{n,m(n)}) database 22.

The Proxy Questions database 16 holds a list of so-called “Proxy” Questions. These questions are essentially prompts with which to elicit information which can be used as a proxy for the idealised information which, if known, would render the decision process under assessment moot. For example, in seeking to assess the exploitation potential of new technologies, if the potential income, potential costs and potential risks associated with exploiting each technology were all known, the decision as to which technology it is best to focus on would be obvious. Each competing technology could be quickly ranked and resources allocated accordingly. In practice however, this information (which shall be referred to generally as the Required Information) is never known, and so, in this invention, other factors are selected to be used as proxies for the potential income, costs and risks. The idea of using this proxy methodology is fundamental to this invention. The Proxy Questions themselves are a valuable tool with which to elicit knowable information from a non-specialist source and the methodology behind their derivation will be explained in more detail later.

The Proxy Statement database 20 stores an n×mₘₐₓ matrix of Proxy Statements (PS_{n,m(n)}). That is, for each one of n Proxy Questions, there is a corresponding set of m(n) answers. Note that the value of m is a function of n. That is, the Questions do not necessarily each have the same number of possible Statements. The database therefore essentially holds null values for Statements indexed between m(n) and mₘₐₓ. In operation, each Proxy Question (PQn) is presented to a user via the interface 12 along with its corresponding Proxy Statements (PS_{n,m(n)}). The user is prompted to select one Proxy Statement from the options presented for each Question and so essentially answers a series of multiple-choice questions. This generates a Response set of n Proxy Statements (PS(nm)), one such Statement being selected for each Proxy Question. The interface 12 passes this Response data (PS(nm)) to the i/o module 24.

Each set of Proxy Statements, that is all m(n) potential answers to Proxy Question n, has a corresponding set of assigned values (AV_{n,m(n)}). These fall within a range from 0.5 to 10 (0 is not permitted), with the highest number within a set being assigned to the “best” answer and the lowest to the “worst” in terms of the implication for the (ideal) Required Information. Thus, using the example of the Proxy Question (PQ₃): “What is the current state of development of the technology?”, the Proxy Statements and their assigned values based on their implication to commercial exploitation of the technology are:

TABLE 1

| | Proxy Statement | Assigned Value |
|---|---|---|
| PS₃₁ | Paper idea only | 1 |
| PS₃₂ | Proof of principle or simulation | 2 |
| PS₃₃ | Bench product or process | 4 |
| PS₃₄ | Fully tested product or process | 6 |
| PS₃₅ | Fully working prototype with documentation | 8 |
| PS₃₆ | Shippable product or turnkey process | 10 |

The full matrix of Assigned Values (AV_{n,m(n)}) is stored in the Assigned Values database 22. Note that there is no requirement for the Assigned Values to be integral, or even for them to span the whole range between 0.5 and 10.

The Weights database 18 contains a set of weightings (wₙ) which reflect the relative importance of each of the n Proxy Questions.

When the i/o module 24 receives the Responses (PS(nm)) from the user, it passes them, along with the set of weightings (wₙ) and relevant Assigned Values (AV(nm)) from databases 18, 22 to the scoring module 26. For each Proxy Statement a score is obtained by multiplying the Assigned Value by the normalised weight. That is:

∃n; scoreₙ=AV(nm)×wₙ

The set of n scores are then passed to the decision tree module 28. The decision tree module 28 aggregates predetermined subsets of the scores i.e.

$$result = {\sum }_{l} {score}_{l} ,$$

where the set of I values is a subset of or equal to the complete set of n indices. The aggregation is essentially a normalised addition of the chosen subset (or set) of scores. That is, the result is a percentage value, expressing the total of the weighted Assigned Values (AV(nm)) of the selected responses as a fraction of the maximum possible total which could have been obtained had the Proxy Statements with maximum Assigned Values been selected for the same subset of scores. The way in which it is determined which particular scores to aggregate corresponds to the relationship between the Proxy Questions and the Required Information, and so will also be addressed in more detail later.

The results so-obtained are returned to the i/o module 24 which in turn passes them to the interface 12 for display to the user. This display is numerical, giving percentage scores for each selected aspect, and also preferably graphical, being arranged to display various scores on a radar graph to permit a fast visual assimilation of the whole picture.

In deriving the Proxy Questions (PQₙ), each is selected to relate to a Proxy Exploitation Factor (PEFₙ) and to elicit information concerning the Proxy Exploitation Factor from the chosen Proxy Statement. The methodology behind the mathematics used to calculate the scores assumes that all the Proxy Exploitation Factors (and therefore associated Proxy Question and Proxy Statement) are independent of each other. This, of course, will not necessarily be the case.

The cross impact analysis module 30 therefore looks at possible cross impacts from the set of Proxy Statements and, rather than incorporating them in the mathematical analysis, identifies and reports them separately, via the interface 12.

The finance module 32 is arranged to provide an estimate (which will inherently be very crude) of potential income and potential costs based on the user's choice of Proxy Statements together with some further input of data and/or expertise.

The operations performed by the cross impact analysis 30 and finance 32 modules are highly dependent on application. They will therefore be discussed in more detail below when attention is focused on a particular implementation of this invention: a software toolkit for use in assessing the exploitation potential of a new technology.

With reference to FIG. 2, a series of operations performed by the abovementioned software toolkit are shown. As in the general implementation of this invention, the first step 50 is to ask the set of Proxy Questions (PQₙ). In this instance there are 12 Proxy Questions related to 12 Proxy Exploitation Factors which have been deduced from a consideration of their relationship to and implications for the Required Information. In this embodiment of the invention the twelve Proxy Exploitation Factors and Questions used are shown in Table 2 below:

TABLE 2

| Proxy Expl. Fact. | | Proxy Question |
|---|---|---|
| Product Benefits | PQ₁ | The new technology will go into a product or |
| | | process - what might be the result? |
| Technology Level | PQ₂ | Is the new technology very high tech or low |
| | | tech, or somewhere in between? |
| Technology | PQ₃ | What is the current state of development of the |
| Status | | technology? |
| Technology | PQ₄ | What proportion of the final product or process |
| Content | | value will the new technology represent |
| Sector | PQ₅ | What is the main industry sector most likely to |
| Attractiveness | | use the product or process containing the new |
| | | technology? |
| Gross Market | PQ₆ | What is the approximate marker size for the |
| Size | | product or process using the new technology? |
| Internal Barriers | PQ₇ | What has happened to the technology with |
| | | respect to the originating organisation |
| Competition | PQ₈ | What is the commercial competition for the |
| | | product or process? |
| External Barriers | PQ₉ | What external barriers might there be to |
| | | exploitation of the technology, product or |
| | | process, e.g. legislation, security, safety, |
| | | politics, public concern? |
| Exploitation | PQ₁₀ | How long might it take before the product |
| Timescale | | could be made into a working product and sold |
| | | commercially? |
| Third Parties | PQ₁₁ | To what extent are third party rights an issue? |
| Intellectual | PQ₁₂ | What intellectual property protection has been |
| Property | | obtained? |

It can readily be seen from the above list of Proxy Questions that they are predominantly phrased in technical terms. This reflects the specific design of the toolkit which is intended for use by scientists and technical experts, with no commercial knowledge, to provide an indication of commercial potential. It is important to realise that no commercial expertise is required of any user; this is sufficiently encapsulated in the structure and values stored within the toolkit (and hidden from the user) to enable production of meaningful results. Clearly, if other users were to be addressed, the Proxy Questions could be phrased differently in order to reflect the new users' expected experience and, if any, field of expertise.

The responses to be given by a user to the above Proxy Questions must be in relation to an anticipated product, and not just to a new technology. These Proxy Questions elicit answers which allow evaluation of various alternative final products, markets and other issues for the same technology, as well as allowing comparison between competing technologies. As an example consider evaluation of a new voice recognition technology. This technology may be incorporated in an office product, in an aid for the disabled or in a children's toy. The answers to many of the above Proxy Questions will be different for each envisaged product. Thus the toolkit can also assist when the conflicting decisions are into which product is it best to incorporate a new technology, as well as into which market is it best to launch it.

These Proxy Questions, displayed on the toolkit input screen, are shown in FIGS. 3A and 3B. The Proxy Questions are displayed adjacent the relevant Proxy Exploitation Factor and above a drop down menu of Proxy Statements available to be selected in response to each Question. A full listing of all Proxy Statements, indexed according to the Questions listed in Table 2, is given in Appendix 1.

The toolkit waits at step 52 until one Proxy Statement has been selected for each question, and then proceeds to send 54 these details to its processor.

The advantages of limiting selection to one Proxy Statement per Question are readily apparent. Clearly the most straightforward comparison between competing opportunities is to produce for each a final “score”. This is done by the scoring module 26 of FIG. 1, but first there is a requirement that every Proxy Question needs to be answered in a way that will generate a numerical value. The most straightforward approach to this would have been to prompt the user to score each question between 1 and 10, with 10 being “excellent”, 1 “very poor” and with a sliding scale in between. The disadvantage of this requirement is that it requires the user to be aware as to what “10” and “1” imply, the steepness of the sliding scale and the linearity or otherwise of such a scale. For example, considering the Proxy Question about technology development cost, if the technology is, say, a process that works on the bench but is not yet a prototype, does that score 4, or 5, or perhaps 8? What would score 10 and what would score 1? This approach would therefore have required some degree of expertise from the user which would severely limit the utility of the toolkit.

The present invention therefore requires that the user is only permitted to select from a list of Proxy Statements, each Statement being previously assigned a value (the Assigned Values AV_{n,m(n)}) which is used in the subsequent scoring calculation. Expert input has been used to assign values to each Proxy Statement PS_{n,m(n)} within the toolkit. These expertly-determined Assigned Values are stored within the Assigned Value database 22 by default. Practically, it is realised that commercial conditions change and it is to be expected that the significance of a Proxy Statement response will be somewhat dependent on the commercial climate at the time. Accordingly, there is a facility within the toolkit which allows an expert user to make adjustments to the Assigned Values which will allow compensation to be made for any variations over time.

The variety of Proxy Statements and determination of their significance in relation to the Proxy Exploitation Factors depends very much on the nature of the Questions and Statements themselves. For this reason expert input is required if meaningful Assigned Values are to be used. To illustrate the different natures, compare the Statements available in response to Proxy Question 3: “what is the current state of development of the technology?” with those available for response to Proxy Question 1: “the new technology will go into a product or process—what might be the result?”. Whilst the Proxy Statements for Proxy Question 3 follow a clear order of progression from “bad for commercial potential” to “good for commercial potential”, range progressions for Statements for Proxy Question 1 are derived from a more complex analysis. Assigned Values for these Statements are derived on expert input using a 3×3 matrix of cost savings versus performance improvement/market growth. Overall cost saving has a higher value than performance improvement, as the latter always comes with some cost (e.g. switching cost) that needs to be overcome. Similarly the Proxy Statements for Proxy Question 5, relating to the Proxy Exploitation Factor of Sector Attractiveness, are derived from expert appraisal of various market sectors for new technology, based on a combination of growth, projected growth, size, openness to new ideas, wealth, fragmentation, speed of new product launch and capital intensity.

The Proxy Statements for Proxy Question 8, Competition, reflect both direct and indirect competition. In addition, a lack of knowledge of the competition has a low value as it is a very high risk situation.

Thus the use of Proxy Statements removes the need to understand the size and gradient of the scale used to generate a score and even the need to allocate a precise scale. Each Proxy Statement is a clear phrase that an expert, inventor or researcher can understand and, more importantly, can easily pick from a proffered range as the one that is the closest fit to the technology being considered.

After the toolkit has read the n Proxy Statements (PS(nm)) selected by the user, the corresponding Assigned Values (AV(nm)) are found along with the appropriate weights (wₙ) for each Proxy Question at step 56. As mentioned previously, the weights wₙ are used in order for the importance of each Proxy Question to be properly reflected in the overall score. A set of default rankings and weightings have been predetermined by expert analysis and the weightings stored in the Weighting database 18 of FIG. 1, for use by the toolkit. Like the determination of Assigned Values therefore, expert input is incorporated into the toolkit, obviating the need for any expert knowledge on the part of the user. These expertly-determined weightings are stored as default initially, but there is again the provision for them to be adjusted by the expert user. Default values are listed in Table 3 below.

TABLE 3

| Ranking | Proxy Exploitation Factor | Weighting wₙ |
|---|---|---|
| 1 | Product or Process Benefits | 25.68 |
| 2 | Sector Attractiveness | 17.41 |
| 3 | Competition | 13.27 |
| 4 | Gross Market Size | 10.51 |
| 5 | External Barriers | 8.44 |
| 6 | Exploitation Timescale | 6.78 |
| 7 | Technology Content | 5.40 |
| 8 | Technology Status | 4.22 |
| 9 | Internal Barriers | 3.19 |
| 10 | Technology Level | 2.97 |
| 11 | Third Parties | 1.44 |
| 12 | Intellectual Property | 0.69 |

The analysis used to generate these rankings and weightings is that of swing rankings and SMART decision analysis, as detailed in “Decision Management Judgement”, Goodwin and Wright, 2001, which in turn draws heavily on the work of Edwards in “Social Utilities”, Engineering Economist, Summer Symposium Series 6, 1971.

The rankings (1 being highest/most important) were determined by a group which included technology development experts, patent experts, commercial experts, inventors and others. The weightings were derived from this by application of a simple linear system of relative weightings: normalised Rank Order Centroid (ROC) Weights, as described in “Smarts and Smarter: Improved Simple Methods for Multi-Attribute Utility Measurement”, Edwards and Barron, 1994.

Returning to the process illustrated in FIG. 2, at step 58, for each Proxy Question (and therefore Proxy Exploitation Factor), the weighting for that Question (wₙ) is multiplied by the Assigned Value (AV(nm)) of the Proxy Statement selected (PS(nm)) to give a score for that Exploitation Factor.

Predetermined arrangements of scores for respective Proxy Exploitation Factors are aggregated together at Step 60. Aggregate scores, referred to herein as Results, are stored as percentages of the maximum possible aggregate score, ready for display. The ways in which particular scores are aggregated to derive particular results are determined by the Decision Tree which is used to generate the initial set of Proxy Exploitation Factors. This will be addressed in detail later.

From the Proxy Statements selected by the user, a cross impact analysis is performed at Step 62. The cross impact analysis raises potential influences one Proxy Exploitation Factor may have on another. Such influences are not incorporated into the scoring system, but a user is made aware when such an influence may arise. In the toolkit for assessment of commercial exploitation of new technology there are six possible cross impacts:

1. If a patent is already filed or granted, but the technology is only a paper idea there may not be sufficient time in which to develop it and still be within the lifetime of the patent, unless further protection is obtained.

2. If a patent is already filed or granted, exploitation timescales of over 10 years are unlikely to generate protectable income unless the product is covered by further patents or other IP protection.

3. If the technology level is high and the timescale to develop is long, the product may be superseded by the time it is ready, especially if it is software.

4. Trying to sell high tech products into slow moving industries or low tech industries may not be worth the effort.

5. If there is a patent granted, or perhaps filed, and there is a product out there already, then there may be real value there due to infringement.

6. If development status is only a paper idea, proof of principle or bench process, then exploitation time cannot be shorter than 5 years.

The relevant cross impacts are therefore selected at step 62 from this list, and prepared for display.

In order to determine whether or not a cross impact has arisen, respective statements reflecting the occurrence of impacts 1 to 6 are provided if the following are true:

1. Qn 12=3,5,7, or 9, and Qn 13≦4

2. Qn 12=3,5,7, or 9 and Qn 10≦5

3. Qn 2≧3 and Qn 10<6

4. Qn 2≧4 and Qn 5≦7

5. Qn 12=3,5,7, or 9 and Qn 8≦4

6. Qn 3≦7 and Qn 10≧5

Where Qn n refers to the Assigned Value of the Proxy Statement selected by the user in response to Proxy Question n.

Even at the first stage of technology assessment, at which this toolkit is designed to assist, it is desirable to start to derive possible incomes from and costs of any potential commercial exploitation. An approximate (order of magnitude, at best) calculation of these factors is therefore made at Step 64 in order to provide financial estimates. These estimates may be refined as the assessment progresses but they will at least indicate caution in proceeding (or indicate that a review of the assessment input is required). At this step simple mathematical calculations are carried out based on the user's choice of Proxy Statements together with some input of historic data and/or expertise.

This financial estimate is based on four additional items of data, known as Assessment Factors, and approximate numerical values which are assigned to seven of the sets of Proxy Statements. Both the Assessment Factors and numerical values are stored within the toolkit and can be changed or updated.

The numerical values associated with those Proxy Statements for which one is relevant have been derived from a relatively crude interpretation of the meaning of the Statement. For example the Proxy Statement “Technology Represents 10%-25% of final product or process value” (PS₄₄) has a numerical value of 17 for use in financial calculations. Similarly various sectors most likely to use the new product or process (PQ₅) are given numerical values of 0.75, 1 or 1.25, which effectively weight initial marketing costs in accordance with the perceived difficulty of a new product breaking into that sector.

Each Assessment Factor has a numerical value, derived in the following way:

1. Market Penetration Factor

i.e. the maximum part of any gross market that might be available to a new product, expressed as a fraction:

| | |
|---|---|
| Value: | 0.1 |
| Reasoning: | Ensures some reality in estimating income. |

2. Technology Development Cost Factor

i.e. an approximate average cost for developing a medium tech technology, expressed in £m:

| | |
|---|---|
| Value: | 0.12 |
| Reasoning: | Assumes reasonable cost and allocation of scientists to |
| | development task. |

3. Marketing Development Cost Factor

i.e. the approximate average annual cost to market medium tech technology, expressed in £m:

| | |
|---|---|
| Value: | 0.09 |
| Reasoning: | Assumes cost of marketing personnel plus reasonable |
| | additional cost of materials. |

4. Extra Up-Front Marketing Time

i.e. the number of additional years over exploitation time for which start-up spending is required:

| | |
|---|---|
| Original Value: | 2.00 |
| Reasoning: | Assumes marketing takes place over a longer time than |
| | development. |

Using these Factors, various estimates of actual spending and income can be made. For example, the user's ball-park estimate of the market for a final product based on the technology (PS₆ₘ) (for example £10 m-£50 m per year, numerical value 25) can be combined with the user's estimate of the proportion of the product value attributable to the technology (PS₄ₘ) (for example, 10%-25%, numerical value 17, as before). Using this together with the Market Penetration Factor allows an order of magnitude estimate to be made of the income that might be generated. (In the examples quoted £25 m×0.17×0.1=£425 000)

The results of Steps 60, 62 and 64 are all sent for display, the display being implemented at Step 66. A typical display resulting from a complete analysis in accordance with this embodiment of the invention is shown in FIG. 4. The results include:

An overall percentage score for the commercial potential of the technology

A guide as to what the score means and what should be done next

Percentage scores for Income, Costs and Risks

Percentage scores for Product, Market and Barrier characteristics * An “order of magnitude” estimate for the potential income to be generated by exploitation of the technology

An “order of magnitude” estimate for the investment costs to exploit the technology

A crude risk analysis

A summary of the Proxy Statements selected, grouped by Product, Market and Barriers

A list of other issues that might arise (if the cross analysis finds anything relevant)

A radar graph giving a visual representation of strengths and weaknesses.

In addition, further enhancements to the system may be made to provide a graphical summary of saved case scores, allowing straightforward visual comparison of exploitation potential between technologies, products or markets.

The crude risk analysis referred to above involves a rewording of particular Proxy Statements such that, if one is selected, a particular risk associated with that situation is highlighted separately to a user. Thus, for example, selection of the Proxy Statement PS₈₃ “It is not yet possible to determine the level of competition ” flags up presentation of a risk: “Competitive situation unknown—very high risk”. Similarly, selection of Proxy Statement PS₅₅ “Defence Sector” as the industry sector most likely to use the product leads to presentation of a risk: “Industry sector of low attractiveness—Defence—high risk”, whereas Proxy Statement PS₅₆ “Electronics Sector” selected in response to the same Proxy Question, leads to presentation of a low risk: “Very attractive industry sector—Electronics—low risk” (see FIG. 4).

Although the embodiment of the toolkit described herein has been directed towards a PC-based implementation, an alternative is, of course, to implement the software on a server-client system. That is the program code can be stored and run on a server with access from a variety of remote sites, or indeed run on a client PC with access given to other PCs via a network.

Of key importance to this toolkit system, and to any system implementing this invention, is the derivation of the Proxy Exploitation Factors from the Required Information. As mentioned previously, this also corresponds to the route which must be traced backwards in order to obtain “scores” relevant to the Required Information from the selected Proxy Statements. This procedure is referred to as adopting a “proxy” methodology. This proxy methodology is entirely novel and central to the analysis tools and methods of this invention.

The proxy methodology focuses on expressing specialist questions and answers in non-specialist (usually general) terms. An interrelationship between the Required Information and Proxy Exploitation factors is derived using decision tree analysis. The specialist expertise is therefore incorporated into the decision tree structure, obviating the need for any such expertise from the user.

In the case of the toolkit described herein, commercial expertise is presented in non-commercial terms. As it is intended for use by scientists, the non-commercial terms are essentially technical, the toolkit thereby providing the means to convert technical input to commercial output. The decision tree analysis adopted uses the “Smarter” technique of Goodwin and Wright, referenced previously. This technique, which has the advantage of its relative simplicity, is considered to be the most appropriate for this embodiment as only a relatively crude estimate of factors is to be derived. Other, more complex, decision tree processes may of course be used, but their level of sophistication is thought to be unwarranted for this application. They may be more appropriately used however in alternative implementations of this invention.

In assessing and evaluating the commercial exploitation potential of a new technology, there are three groups of “Required Information” that are needed:

Potential Income

Potential Costs

Potential Risks

In any situation, it is never possible to know truly what these may be, but it is often possible to obtain information about factors such as:

The Product

The Market

Barriers

The above “Information Sources” are generally used by an expert to deduce approximations to the Required Information, from which, in turn, an assessment of commercial exploitation potential can be made.

FIGS. 5A and B are schematic representations of the decision tree by which the Required Information is linked to the ultimately knowable, Proxy Exploitation Factors of the specific toolkit derived herein. FIG. 5A represents the first stage of a decision tree analysis and FIG. 5B the fully expanded tree.

As a first stage in the analysis the various components of Market, Product and Barriers are set up as proxies for the Required Information of Income, Risks and Costs for exploitation of the technology. A complete analysis would take into account contributions of all three proxies to each element of the Required Information. To a first order estimate however, the contribution made by Barriers to either Income or Costs is considered, by the expert analysis used in designing this specific toolkit, less significant than that made by the other proxies. There is therefore assumed to be some input from Product and Market information into Income; from Product and Market information into Costs and from Product, Market and Barriers Information into Risks. Note that other expert analyses may result in different contributions, the one described herein is that considered, by the expert(s) consulted, most appropriate for the intended application of the toolkit to technical/commercial conversion. At the first stage of analysis, which is, it is stressed, intended to only be a very crude approximation, the decision tree is as shown in FIG. 5A.

With reference to this Figure, a top level 82 of a decision tree 80 represents the aim of the assessment: What is the commercial potential of a new technology? This is subdivided into three next-level 84 branches of Required Information: representing Income, Costs and Risks. One level 86 below that are the proxies we are using to obtain information: Product, Market and Barriers. In order to expand to a further level, components of Product, Markets and Barriers which influence Income, Costs and Risks need to be identified.

With reference to FIG. 5B, the final level(s) 88, 90 of the expanded tree are shown. At this stage of the analysis, it was determined that, to a first order approximation, bearing in mind the relatively crude indications required, no component of Market provides a significant input to Costs. This branch of the tree is therefore represented no further. Conversely, it was found that Technical Development, a component of the contribution to potential Costs made by the Product incorporating the new technology, should be sub-divided further in order to allow technical non-experts to better provide information relevant to generating a commercial score. Accordingly in this region, the tree shows an additional branching, representing the separate and quantifiable contributions made by Technical Level and Technical Status to Product information which has a bearing on potential exploitation Costs.

Referring to this diagram, the boxed items 101-112 refer to information which is to be collected when the method behind this invention is completed—the Proxy Exploitation Factors. That is, obtainable information, such as technology content 102, market competition 108 and exploitation timescale 109 are components of Market, Product and Barriers information which in turn are used as proxies for Income, Costs and Risks involved in exploitation of the invention.

As an example, to make an estimate of the costs involved in bringing a new technology to a point where it is commercially viable, the simplest proxy is the current Technology Status 105. A technology that is no more than an “idea on paper” (whether patented or not) will cost much more to develop to a commercial product than a similar technology that has reached the “working prototype” stage. A second proxy is the nature or level of technology 104. A technology that is high tech will tend to cost more to develop than a low technology.

Returning to the specific analysis provided by the toolkit described herein, use of the software produces at step 58 (see FIG. 2), for each new technology product or process, a set of scores, each of which is associated with one Proxy Exploitation Factor. In order to obtain the various Results at step 60 therefore, it can be seen that the scores merely need to be aggregated according to the structure of the decision tree to give percentage scores for each “branch” of the tree, and finally an aggregated score over all branches to give an overall percentage score.

As an illustrative example, consider obtaining a result indicating the overall Market for a product. There are three Proxy Exploitation Factors which contribute: Gross Market Size 103, Sector Attractiveness 107 and Competition 108. The three weighted scores for each of the Proxy Statements (PS₆ₘ, PS₅ₘ, PS₈ₘ) given in response to the relevant Proxy Questions (PQ₆, PQ₅, PQ₈) are added together and the result presented as a percentage of the maximum score which could have been obtained for the same summation of scores for the same Proxy Questions. That is, the “best” answer for PQ₆ is that the market size is over £500 m per year, which has an Assigned Value of 10. Similarly the software sector would have returned an Assigned Value of 9.75 had that been selected for PQ₅ and the “best” available competition response is that potential users are currently making do with something that is not ideal. The Assigned Values for these responses, weighted according to values given in Table 3, add together to give a maximum possible score of 381. Thus, the actually obtained score for the potential Market for the product in question will be a percentage of this maximum.

Similarly, to provide an indication of the potential Costs of exploiting a new product or process, weighted scores for the responses given to the three Proxy Questions (PQ₂, PQ₃, PQ₁₂) whose Proxy Exploitation Factors 104, 105, 106 are linked to Costs in the decision tree are added together and normalised in accordance with the maximum possible score which could have been obtained from consideration of these Factors.

The method and system of the present invention can thus be seen to present an implementation of a proxy methodology to generate useful information in a form suitable for straightforward visual comparison. That is, percentages obtained by consideration of different scenarios can be readily compared.

As previously indicated, the toolkit is flexible enough to allow expert users access to apply their own expert knowledge in setting both the Assigned Values (AV_{n,m(n)}) and weightings (wₙ) used in analysing the results of the selected Proxy Statements. However expert users should not change the nature of the Proxy Exploitation Factors. The underlying logic of a toolkit developed for any specific application (in this case to assess commercial exploitability from technical information) rests on these Factors and their position in the decision tree. Changes should therefore be limited to those that might make the Exploitation Factors clearer for specific users, while retaining the original concept. Similarly the Proxy Questions should remain substantially unchanged, with only minor amendments being permitted to make the questions more relevant to particular users.

### APPENDIX 1

Proxy Statements

Q1 Product Benefits

PQ₁ The new technology will go into a product or process—what might be the result?

No answer yet selected

PS₁₁ Some performance improvement at very little cost

PS₁₂ Significant performance improvement, which will open a new market

PS₁₃ Obvious and significant cost savings on an existing product

PS₁₄ Cost savings possible on existing products

PS₁₅ Both significant performance improvement and significant cost savings

PS₁₆ Improved performance possible, but at a cost

PS₁₇ Significant performance improvement at some cost

Q2 Technology Level

PQ₂ Is the final product very high tech or low tech, or somewhere in between?

No answer yet selected

PS₂₁ Low tech product or process

PS₂₂ Medium tech product or process

PS₂₃ New software

PS₂₄ High tech product with or without accompanying software

PS₂₅ Very high tech and complex product or process

Q3 Technology Status

PQ₃ What is the current state of development of the technology?

No answer yet selected

PS₃₁ Paper idea only

PS₃₂ Proof of principle or simulation

PS₃₃ Tested bench product or process

PS₃₄ Fully tested product or process

PS₃₅ Fully working prototype with documentation

PS₃₆ Shippable product or turnkey process

Q4 Technology Content

PQ₄ What proportion of the final product or process value will the new technology represent?

No answer yet selected

PS₄₁ Technology represents up to 1% of final product or process value

PS₄₂ Technology represents 1%-5% of final product or process value

PS₄₃ Technology represents 5%-10% of final product or process value

PS₄₄ Technology represents 10%-25% of final product or process value

PS₄₅ Technology represents 25%-50% of final product or process value

PS₄₆ Technology represents 50%-75% of final product or process value

PS₄₇ Technology represents 75%-100% of final product or process value

Q5 Sector Attractiveness

PQ₅ What is the main industry sector most likely to use the product or process containing the new technology?

No answer yet selected

These sectors cannot be changed

PS₅₁ Aerospace sector

PS₅₂ Chemicals sector (including pharmaceutical chemicals)

PS₅₃ Computers sector

PS₅₄ Construction sector

PS₅₅ Defence sector

PS₅₆ Electronics sector

PS₅₇ Energy sector

PS₅₈ Finance sector

PS₅₉ Healthcare sector

PS₅₁₀ Leisure sector

PS₅₁₁ Media sector

PS₅₁₂ Mining sector

PS₅₁₃ Retail sector

PS₅₁₄ Software sector

PS₅₁₅ Telecom sector

PS₅₁₆ Textiles sector

PS₅₁₇ Transport sector

PS₅₁₈ Utilities sector

Q6 Gross Market Size

PQ₆ What is the approximate market size for the product or process using the new technology?

No answer yet selected

PS₆₁ Potential market for the final product or process is up to £10 m per year

PS₆₂ Potential market for the final product or process is £10 m-£50 m per year

PS₆₃ Potential market for the final product or process is £50 m-£100 m per year

PS₆₄ Potential market for the final product or process is £100 m-£500 m per year

PS₆₅ Potential market for the final product or process is >£500 m per year

Q7 Internal Barriers

PQ7 What has happened to the technology with respect to the originating organisation?

No answer yet selected

PS₇₁ Technology championed by inventor and/or research group only.

PS₇₂ Technology actively supported by ‘Department Head’ only

PS₇₃ Technology actively supported by ‘Divisional Directors’

PS₇₄ Technology previously rejected by peers/management on technical grounds

PS₇₅ Previously rejected due to low priority in funding

PS₇₆ No previous consideration of commercial exploitation

Q8 Competition

PQ₈ What is the commercial competition for the product or process?

No answer yet selected

PS₈₁ The benefits a user would obtain from the product are already available from someone else

PS₈₂ A very similar product or process already exists

PS₈₃ It is not yet possible to determine the level of competition.

PS₈₄ Potential users are currently making do with something that is not ideal

Q9 External Barriers

PQ₉ What external barriers might there be to exploitation of the technology, product or process, e.g. legislation, security, safety, politics or public concern.

No answer yet selected

PS₉₁ External barriers are known but they are probably not very significant

PS₉₂ External barriers may exist but their significance is unknown

PS₉₃ Significant external barriers exist

PS₉₄ It is not yet possible to determine if there are any external barriers

Q10 Exploitation Timescale

PQ₁₀ How long might it take before the product could be made into a working product and sold commercially?

No answer yet selected

PS₁₀₁ More than 15 years to a shippable product

PS₁₀₂ More than 10 years to a shippable product

PS₁₀₃ Five to ten years to a shippable product

PS₁₀₄ Three to five years to a shippable product

PS₁₀₅ Less than three years to a shippable product

PS₁₀₆ Less than 1 year to a shippable product

Q11 Third Parties

PQ₁₁ To what extent are third party rights an issue?

No answer yet selected

PS₁₁₁ All the IP is owned

PS₁₁₂ There are third party IP rights that are essential but not yet negotiated.

PS₁₁₃ Not all IP owned but there are rights to use third party IP

PS₁₁₄ There are third party IP rights that are essential but not currently available

PS₁₁₅ All the IP is owned but other parties have user rights

Q12 Intellectual Property

PQ₁₂ What intellectual property protection has been obtained?

No answer yet selected

PS₁₂₁ A patent has been filed

PS₁₂₂ International patent filing begun

PS₁₂₃ International patents granted

PS₁₂₄ Searches done and information prepared

PS₁₂₅ Need for know-how or trademark potential or design registration identified

PS₁₂₆ Know-how protected by all encompassing contracts or trademark registration or design registered

PS₁₂₇ No preparation for any IP protection

1. A method of decision tree analysis by which a goal (82) to be assessed in terms of a comparison between a number of different scenarios is linked with quantifiable parameters (101-112), thereby enabling a quantitative value to be obtained as a measure of the goal (82), the method comprising the steps of:
(a) At a first level of the decision tree, associating the goal (82) with Required Information (84) which, if all aspects of the Required Information (84) were known, would enable a straightforward assessment of the goal (82) to be made for each of the different scenarios;
(b) At a second level of the decision tree, linking proxy information (86) to the Required Information (84) wherein the proxy information (86) comprises a number of aspects, each of which is a generally estimable parameter, and each aspect of the proxy information (86) is assumed to make a contribution to each aspect of the Required Information (84); and
(c) At a third and, possibly, subsequent level of the decision tree, extracting Proxy Factors (101-112), the Proxy Factors (101-112) being not insignificant components of each aspect of the proxy information (86) linked to one of the aspects of the Required Information through the decision tree structure and wherein the Proxy Factors (101-112) are quantifiable parameters.

2. A method according to claim 1 wherein the method further comprises the steps of:
(a) Obtaining quantities (scoreₙ) representative of the Proxy Factors (101-112), and
(b) For at least one of:
each aspect of Required Information (84),
each aspect of proxy information (86), and
the overall goal (82),
generating a Result for comparison between the different scenarios wherein each respective Result is generated by aggregating and normalising the representative quantities (scoreₙ) in accordance with links established by the decision tree structure.

3. A method according to claim 2 wherein the representative quantities of step (a) are obtained by the steps of:
(a) Presenting to a user a series of predetermined Proxy Questions (PQₙ), wherein each Proxy Question relates to a Proxy Factor (101-112),
(b) Prompting the user to select, for each Proxy Question (PQₙ), one of a number of predetermined Proxy Statements (PS_{n,m(n)}), each Proxy Statement being a relevant answer to its respective Proxy Question (PQₙ), and,
(c) On selection by the user of one Proxy Statement (PS(nm)) for each Proxy Question (PQₙ), multiplying a predetermined Assigned Value (AV(nm)) for the Proxy Statement (PS(nm)), the Assigned Value being a numerical representation of the benefit of the selected Proxy Statement (PS(nm)) to the goal (82) relative to the benefit of all the unselected Statements corresponding to the same Proxy Question (PQₙ), by a predetermined weighting (wₙ) for the Proxy Question (PQₙ), the weighting being a numerical representation of the magnitude of the effect on the goal (82) of the Proxy Factor (101-112) corresponding to the Proxy Question (PQₙ), and to generate the Result (scoreₙ).

4. The method according to claim 1, 2 or 3 wherein the goal (82) to be assessed is the commercial potential of new technology, the Required Information comprises three aspects relating to Income, Costs and Risks, the proxy information comprises three aspects relating to Product, Market and Barriers, and the Proxy Factors (101-112) are Proxy Exploitation Factors.

5. A method according to claim 4 wherein the Proxy Exploitation Factors (101-112) relate to at least three of: Product or Process Benefits, Sector Attractiveness, Competition and Gross Market Size.

6. A method according to claim 5 wherein the Proxy Exploitation Factors (101-112) further relate to at least one of: External Barriers, Exploitation Timescale, Technology Content and Technology Status.

7. A method according to claim 6 wherein the Proxy Exploitation Factors (101-112) further relate to at least one of: Internal Barriers, Technology Level, Third Parties and Intellectual Property.

8. A method of generating a quantitative value representative of potential for achieving a goal (82), the method comprising the steps of:
(a) presenting (50) to a user a series of predetermined Proxy Questions (PQₙ) and, for each Proxy Question (PQₙ), a set of Proxy Statements (PS_{n,m(n)}); wherein each Proxy Question (PQₙ) has a predetermined associated Weighting value (wₙ) and each Proxy Statement (PS_{n,m(n)}) has a pre-determined associated Assigned Value (AV_{n,m(n)});
(b) accepting (54) a Response comprising a selected set of Proxy Statements (PS(nm)) from the user;
(c) replacing (56) each Proxy Statement (PS(nm)) within the Response with its associated Assigned Value (AV(nm));
(d) multiplying (58) each Assigned Value (AV(nm)) by the Weighting value (wₙ) associated with the Proxy Question (PQₙ) which prompted for its associated Proxy Statement (PS(nm)) to obtain a set of score indicators (scoreₙ);
(e) aggregating (60) predetermined combinations of score indicators (scoreₙ) together to obtain a selection of result indicators; and
(f) displaying (66) the result indicators to the user.

9. A method according to claim 8 wherein the weightings (wₙ) are predetermined in accordance with an estimated effect of a Proxy Factor (101-112), associated with each Proxy Question (PQₙ), on achieving the goal (82) and the Assigned Values (AV_{n,m(n)}) are predetermined in accordance with an estimated benefit of the associated Proxy Statement (PS_{n,m(n)}), relative to estimated benefits of Proxy Statements (PS_{n,m(n)}) within the same set, to the goal (82).

10. A method according to claim 9 wherein the combinations of score indicators (scoreₙ) which are aggregated together at Step (e) to obtain a selection of result indicators are predetermined in accordance with a decision tree structure, the decision tree being established by a method comprising the steps of:
(a) At a first level of the decision tree, associating the goal (82) with Required Information (84) which, if all aspects of the Required Information (84) were known, would enable a straightforward assessment of the goal (82) to be made for each of the different scenarios,
(b) At a second level of the decision tree, linking proxy information (86) to the Required Information (84) wherein the proxy information (86) comprises a number of aspects, each of which is a generally estimable parameter, and each aspect of the proxy information (86) is assumed to make a contribution to each aspect of the Required Information (84), and
(c) At a third and, possibly, subsequent level of the decision tree, extracting the Proxy Factors (101-112), the Proxy Factors (101-112) being not insignificant components of each aspect of the proxy information (86) linked to one of the aspects of the Required Information through the decision tree structure and wherein the Proxy Factors (101-112) are quantifiable parameters;
and whereby the combinations of score indicators (scoreₙ) are aggregated in accordance with the links between the Proxy Factors (101-112) corresponding via the Proxy Questions (PQₙ) to the Proxy Statements (PS(nm)) selected and at least one aspect of Required Information (84), proxy information (86) or the overall goal (82), wherein the links are followed backwards through the decision tree structure to provide the result indicator which is therefore a measure of the particular aspect selected, in a scenario for which the user-selected Proxy Statements (PS(nm)) apply.

11. The method according to claim 10 wherein the goal (82) is commercialisation of new technology, and the Proxy Questions (PQₙ) are designed to elicit responses appropriate for the assessment of the Proxy Factors (101-112), which in turn are components of three aspects of proxy information (86) relating to Product, Market and Barriers for or to the commercial exploitation of the new technology, and the Required Information relates to Income, Costs and Risks involved with exploiting the new technology.

12. The method according to claim 11 wherein the Proxy Factors (101-112) relate to at least three of: Product or Process Benefits, Sector Attractiveness, Competition and Gross Market Size.

13. The method according to claim 12 wherein the Proxy Factors (101-112) further relate to at least one of: External Barriers, Exploitation Timescale Technology Content and Technology Status.

14. The method according to claim 13 wherein the Proxy Factors (101-112) further relate to at least one of: Internal Barriers, Technology Level, Third Parties and Intellectual Property

15. A computer system (10) configured to provide scores for the purpose of assessing competing demands on resources, the system comprising:
memory means (16, 18, 20, 22) for storing data comprising Proxy Questions (PQₙ), weightings (wₙ) for each Proxy Question (PQₙ), Proxy Statements (PS_{n,m(n)}) and Assigned Values (AV_{n,m(n)}) associated with the Proxy Statements (PS_{n,m(n)}),
a display means arranged to display the Proxy Questions (PQₙ) and, for each Proxy Question (PQₙ), a set of Proxy Statements (PS_{n,m(n)}) in a format to prompt the user to select one Proxy Statement (PS(nm)) from the set,
input means arranged to accept inputs from the user, the inputs being characteristic of the Proxy Statements (PS(nm)),
interface means (12) arranged to provide communication between the display means, input means and the rest of the computer (10),
a processor (14), the processor (14) being responsive to the inputs characteristic of the Proxy Statements (PS(nm)) selected to determine a series of scores relating to this combination of Proxy Statements (PS(nm)) and to output the series of scores or a subset thereof via the interface (12) for display by the display means, wherein
the Proxy Questions (PQₙ) are associated with respective Proxy Factors (101-112) in such a way that an answer (PS_{n,m(n)}) to the Question (PQₙ) is informative as to an impact of the associated Proxy Factor (101-112),
the Proxy Factors (101-112) are derived from a decision tree structure, in which linkages are provided between the Proxy Factors (101-112) and aspects of proxy information (86) and between the aspects of proxy information (86) and aspects of Required Information (84), the Required Information being that which, if known, would permit a straightforward assessment of the competing demands to be made, and
the proxy information (86) comprises parameters which are more readily estimable than the aspects of the Required Information (84).

16. A computer system according to claim 15 wherein the processor 14 further includes
scoring means (26) for calculating a series of score indicators (scoreₙ), one for each user-selected Proxy Statement (PS(nm)), wherein each score indicator (scoreₙ) is calculated by multiplying the Assigned Value (AV(nm)) associated with that user-selected Proxy Statement (PS(nm)) by the weighting (wₙ) for the Proxy Question (PQₙ) which elicited input of that user-selected Proxy Statement (PS(nm)), whereby each score indictor (scoreₙ) can be considered a measure of the contribution of the associated Proxy Factor (101-112) to the overall assessment being made, and
a decision tree module (28) arranged to aggregate combinations of score indicators (scoreₙ), each such combination corresponding to linkages in the decision tree structure between one aspect of Required Information (84), one aspect of proxy information (86) or the whole tree and the Proxy Factor(s) (101-112), thereby providing quantitative values which can be used to assess the competing demands of different scenarios with different sets of user-selected Proxy Statements (PS(nm)).

17. A computer system according to claim 16 wherein the demand to be assessed is based on the commercial potential of new technology, and the Proxy Questions (PQₙ) are designed to elicit responses appropriate for the assessment of the Proxy Factors (101-112), which in turn are components of three aspects of proxy information (86) related to Product, Market and Barriers for or to the commercial exploitation of the new technology, and the Required Information relates to Income, Costs and Risks involved with exploiting the new technology.

18. A computer system according to claim 17 wherein the Proxy Factors (101-112) relate to at least three of: Product or Process Benefits, Sector Attractiveness, Competition and Gross Market Size.

19. A computer system according to claim 18 wherein the Proxy Factors (101-112) further relate to at least one of: External Barriers, Exploitation Timescale, Technology Content and Technology Status.

20. A computer system according to claim 19 wherein the Proxy Factors (101-112) further relate to at least one of: Internal Barriers, Technology Level, Third Parties and Intellectual Property.

21. A computer-readable medium embodying instructions for execution by a processor, the computer-readable medium comprising:
(a) Program code for presenting (50) to a user a series of predetermined Proxy Questions (PQₙ) and, for each Proxy Question (PQₙ), a set of Proxy Statements (PS_{n,m(n)}); wherein each Proxy Question (PQₙ) has a predetermined associated normalised Weighting value (wₙ) and each Proxy Statement (PS_{n,m(n)}) has a pre-determined associated Assigned Value (AV_{n,m(n)});
(b) Program code for accepting (54) a Response comprising a selected set of Proxy Statements (PS(nm)) from the user;
(c) Program code for replacing (56) each Proxy Statement (PS(nm)) within the Response with its associated Assigned Value (AV(nm));
(d) Program code for multiplying (58) each Assigned Value (AV(nm)) by the Weighting value (wₙ) associated with the Proxy Question (PQₙ) which prompted for its associated Proxy Statement (PS(nm)) to obtain a set of score indicators (scoreₙ);
(e) Program code for aggregating (60) predetermined combinations of score indicators (scoreₙ) together to obtain a selection of result indicators; and
(f) Program code for displaying (66) the result indicators to the user.
